(19) United States
(12) Patent Application Publication
(10) Pub. No.: US 2010/0134395 A1
(43) Pub. Date: Jun. 3, 2010

(54) LIGHTING SYSTEM AND DISPLAY DEVICE EQUIPPED WITH THE SAME

(75) Inventor: Yoshiki Takata, Osaka (JP)

Correspondence Address: NIXON & VANDERHYE, PC, 901 NORTH GLEBE ROAD, 11TH FLOOR, ARLINGTON, VA, 22203, US

(73) Assignee: SHARP KABUSHIKI KAISHA, Osaka-shi, Osaka (JP)

(21) Appl. No.: 12/596,742

(22) PCT Filed: Apr. 16, 2008
(86) PCT No.: PCT/JP2008/057436

§ 371 Date: Oct. 20, 2009

(30) Foreign Application Priority Data
Apr. 20, 2007 (JP) 2007-112264

(51) Int. Cl. G09G 3/36; G09F 13/04

(52) U.S. Cl. 345/89; 362/97.1

(57) ABSTRACT

A display apparatus that can perform even a high quality moving picture display and provides improved color purity, and an illumination device used in the display apparatus are provided. The display apparatus includes: an illumination device (3) that includes a first light source (31G) that emits light of a first color and a second light source (31RB) that emits light of a second color complementary to the first color; a gate driver (24) that sequentially selects each of scanning lines GL at a cycle of 0.5 frames; a source driver (23) that, at a first half of one frame time period, writes a data signal into each of pixels of the first color, and at a latter half thereof, writes a data signal into each of pixels of the other two colors; and a switch circuit (26) that, at the first half of one frame time period, switches on the first light source while switching off the second light source, and at the latter half of the time period, switches on the second light source while switching off the first light source.

### TECHNICAL FIELD

The present invention relates to an illumination device used as a backlight of a display apparatus and to a display apparatus including the same. This invention particularly relates to an illumination device and a display apparatus that can provide improved color purity in a color display.

### BACKGROUND ART

In recent years, as a display apparatus for a television receiver or the like, liquid crystal display apparatuses characterized by, for example, being reduced in power consumption, thickness and weight have found widespread use. A liquid crystal display element per se does not emit light and thus is a so-called non-light-emitting type display element. Therefore, for example, on one principal surface of the liquid crystal display element, a plane light-emitting type illumination device (so-called backlight) is provided.

Backlights are classified roughly into a direct type and a sidelight (referred to also as “edge-light”) type depending on an arrangement of a light source with respect to a liquid crystal display element. A direct type backlight has a configuration in which a light source is disposed on a rear surface side of a liquid crystal display element, and a diffusing plate, a prism sheet and the like are disposed between the light source and the liquid crystal display element so that uniform plane-shaped light is made incident on an entire rear surface of the liquid crystal display element. Such a direct type backlight has been used suitably in, for example, a large-screen liquid crystal display apparatus for a television receiver.

As a conventional light source for a backlight, a cold cathode fluorescent tube (CCFT) has been in common use. Further, with the recent advancement in development of a light-emitting diode (LED) having higher color reproducibility than a cold cathode fluorescent tube, a LED also has been used suitably as a light source for a backlight.

Furthermore, conventionally, a color display has been realized by color filters of three colors of RGB that are provided so as to correspond to pixels of a liquid crystal display element. FIG. 16 is a schematic diagram showing a structure of an active matrix substrate in a conventional active matrix type liquid crystal display element, in which each pixel is shown with a color of color filters corresponding thereto. As shown in FIG. 16, the active matrix substrate includes scanning lines GL and data lines DL that are arranged in a matrix form, a TFT 101 that is disposed at each of intersections of the scanning lines GL and the data lines DL, and a pixel electrode 102 that is connected to a drain electrode of the TFT 101. On an opposing substrate (not shown) opposed to this active matrix substrate, color filter layers of three colors of RGB are formed in stripes. Thus, as shown in FIG. 16, all of pixels in one column connected commonly to each of the data lines DL display one of the colors of RGB. For example, in FIG. 16, all of pixels connected to the data line DL1 display red (R).

In the active matrix type liquid crystal display element configured as above, when a gate pulse (selective voltage) is applied sequentially to the scanning lines GL1, GL2, GL3, GL4, . . . , each of the TFTs 101 connected to one of the scanning lines GL, to which the gate pulse has just been applied, is brought to an ON state, and a value of a gradation voltage that has been applied to a corresponding one of the data lines DL at that point in time is written into the each of the TFTs 101. Consequently, a potential of the pixel electrode 102 connected to a drain electrode of the each of the TFTs 101 becomes equal to the value of the gradation voltage of the corresponding one of the data lines DL. As a result of this, an orientation state of liquid crystals interposed between the pixel electrode 102 and an opposing electrode changes in accordance with the value of the gradation voltage, and thus a gradation display of said pixel is realized. On the other hand, during a time period in which a non-selective voltage is applied to the scanning lines GL, the TFTs 101 are brought to an OFF state, so that the potential of the pixel electrode 102 is maintained at a value of a potential applied thereto at the time of writing.

As described above, in the conventional liquid crystal display element, the color filters of three colors of RGB are arranged in an orderly manner, and while the scanning lines GL are selected sequentially in one frame time period, a gradation voltage of a desired value is applied to each of pixels that correspond to each of the colors of RGB from a corresponding one of the data lines DL, thereby realizing a color display.

As a CFT used as a light source for a backlight of the above-described conventional liquid crystal display element that performs a color display, a three-wavelength tube or a four-wavelength tube is in general use. The three-wavelength tube is a fluorescent tube having wavelengths of red (R), green (G), and blue (B), and the four-wavelength tube is a fluorescent tube having wavelengths of red, green, blue, and deep red In the case of the three-wavelength tube, red, green, and blue phosphors are sealed in the tube. In the case of the four-wavelength tube, red, green, blue, and deep red phosphors are sealed in the tube. In either of these cases, at the time of lighting, mixing of light of the respective wavelengths occurs, so that the liquid crystal display element is irradiated with the light that is light (white light) having an emission spectrum in all wavelength regions. Further, in the case where a LED is used as a light source for a backlight, a prism sheet, a diffusing plate and the like are used to mix the respective colors of light outputted from a red LED, a green LED, and a blue LED (a white LED further may be used) so as to form uniform white light, with which the liquid crystal display element then is irradiated.

The following describes a problem with the case where a light source having wavelength regions of the respective colors of red, green, and blue is used as a light source for a backlight.

FIG. 17 is a spectrum diagram showing spectral transmission characteristics of color filters of three colors of RGB. As shown in FIG. 17, the respective spectral transmission spectra of the blue color filter and the green color filter overlap in an area defined by a range of about 470 nm to 570 nm. Further, the respective spectral transmission spectra of the green color filter and the red color filter overlap in an area defined by a range of about 575 nm to 625 nm. Because of this, in the case of using a light source for a backlight having an emission spectrum in all wavelength regions, color mixing occurs in these areas in which the respective spectral transmission spectra overlap, resulting in deterioration in color purity, which has been disadvantageous.

For example, FIG. 18A shows an emission spectrum of a three-wavelength tube, FIG. 18B shows a spectral transmission characteristic of a red color filter in the case where this three-wavelength tube is used as a light source for a backlight, FIG. 18C shows a spectral transmission characteristic of a green color filter in the case where this three-wavelength tube is used as the light source for the backlight, and FIG. 18D shows a spectral transmission characteristic of a blue color filter in the case where this three-wavelength tube is used as the light source for the backlight.

As can be seen from FIG. 18C, a spectral transmission curve of the green color filter partially overlaps a wavelength region of blue. This means that a blue component is mixed into a pixel that is to be displayed in green. Further, as can be seen from FIG. 18D, a spectral transmission curve of the blue color filter also partially overlaps a wavelength region of green. This means that a green component is mixed into a pixel that is to be displayed in blue. Such a color mixing phenomenon occurs also in the case of using a four-wavelength tube as a light source for a backlight and has been a cause of deterioration in color purity.

Conventionally, in order to obtain improved color purity, a driving method (so-called field sequential driving) has been proposed in which LEDs of three colors of RGB are used as light sources for a backlight with respect to a liquid crystal display element including color filters of three colors of RGB, and the LEDs of the respective colors are caused to blink sequentially so that an image of red alone, an image of green alone, and an image of blue alone are displayed in order in one frame (see Patent Document 1).
Patent Document 1: JP 2003-271100 A (paragraphs [0064] to [0076])

### DISCLOSURE OF INVENTION

### Problem to be Solved by the Invention

However, in the above-described configuration according to the conventional technique, when a frame rate is increased such as in the case where a moving picture display of a high-resolution image is performed, a problem arises that the field sequential driving in which a display is performed in such a manner that one frame is divided into three colors hardly can be performed. Particularly, in the case of a liquid crystal display apparatus, at least presently, a response speed of liquid crystals is not so high as to be sufficient, rendering it almost impossible to realize a high quality moving picture display by the field sequential driving.

With the foregoing in mind, it is an object of the present invention to provide a display apparatus that can perform even a high quality moving picture display and provides improved color purity and an illumination device used in the display apparatus, and particularly to achieve excellent white balance by balancing, with respect to a first light source that emits light of a first color and a second light source that emits light of a second color complementary to the first color, which are used in the illumination device, the amounts of irradiation light of the first and second light sources.

### Means for Solving Problem

In order to achieve the above-described object, an illumination device according to the present invention is an illumination device that is used as a backlight of a display apparatus and is characterized by including: a first light source that emits light of a first color; and a second light source that emits light of a second color complementary to the first color. In the device, each of the first light source and the second light source is a fluorescent tube having a cold cathode or a hot cathode, an amount of light emitted by the first light source is smaller than an amount of light emitted by the second light source, and the first light source and the second light source can be controlled so as to be switched on independently of each other.

Furthermore, a display apparatus according to the present invention is characterized by including: a display element that includes: scanning lines and data lines that are arranged in a matrix form; a switching element that is connected to each of the scanning lines and a corresponding one of the data lines; a pixel portion that performs a gradation display in accordance with a data signal written from the corresponding one of the data lines when the switching element is brought to an ON state based on a signal of the each of the scanning lines; and color filters that are arranged so as to correspond to the pixel portions and include at least filters of three colors that exhibit a white color when mixed; an illumination device that outputs plane-shaped light to the display element and includes a first light source that emits light of a first color that is one of the three colors and a second light source that emits light of a second color complementary to the first color, and in which each of the first light source and the second light source is a fluorescent tube having a cold cathode or a hot cathode, and an amount of light emitted by the first light source is smaller than an amount of light emitted by the second light source; a scanning line driving portion that sequentially supplies a selection signal to each of the scanning lines at a cycle of half a time period in which one image is displayed in the display element; a data line driving portion that, at one of a first half and a latter half of the time period in which one image is displayed in the display element, supplies a data signal to be written into each in a group of pixel portions among the pixel portions that corresponds to the color filter of the first color to a corresponding one of the data lines, and at an other of the first half and the latter half of the time period, supplies a data signal to be written into each in groups of pixel portions among the pixel portions that correspond respectively to the color filters of two colors among the three colors other than the first color to a corresponding one of the data lines; and a light source driving portion that, at the one of the first half and the latter half of the time period in which one image is displayed in the display element, switches on the first light source while switching off the second light source, and at the other of the first half and the latter half of the time period, switches on the second light source while switching off the first light source.

### Effects of the Invention

According to the present invention, it is possible to provide a display apparatus that can perform even a high quality moving picture display and provides improved color purity, and an illumination device used in the display apparatus. Particularly, in the illumination device, with respect to a first light source that emits light of a first color and a second light source that emits light of a second color complementary to the first color, the amount of light emitted by the first light source is balanced with the amount of light emitted by the second light source so that excellent white balance can be achieved, thereby making it possible to realize a high quality moving picture display and further improved color purity, which characterize the display apparatus of the present invention.

### BRIEF DESCRIPTION OF DRAWINGS

FIG. 1 is a cross-sectional view showing a schematic configuration of a liquid crystal display apparatus according to one embodiment of the present invention.

FIG. 2 shows graphs of spectrum intensities of an illumination device according to one embodiment of the present invention.

FIG. 3 shows graphs of spectrum intensities in a comparative example of the illumination device.

FIG. 4 is a block diagram showing a functional configuration of a liquid crystal display apparatus according to a first embodiment of the present invention.

FIG. 5 is a timing chart showing one example of a relationship among timing for switching on/off light sources, timing for supplying a data signal to each of data lines, and amounts of light emitted by the light sources in the liquid crystal display apparatus according to the first embodiment of the present invention.

FIG. 6 is a liming chart showing another example of the relationship among timing for switching on/off the light sources, timing for supplying a data signal to each of the data lines, and amounts of light emitted by the light sources in the liquid crystal display apparatus according to the first embodiment of the present invention.

FIG. 7A is a spectrum diagram showing a spectral characteristic of a cold cathode fluorescent tube 31RB, FIG. 7B is a spectrum diagram showing a spectral characteristic of a cold cathode fluorescent tube 31G, FIG. 7C is a spectrum diagram showing a spectral characteristic of light that is transmitted through a pixel corresponding to a red color filter when the cold cathode fluorescent tubes 31RB are switched on, FIG. 7D is a spectrum diagram showing a spectral characteristic of light that is transmitted through a pixel corresponding to a green color filter when the cold cathode fluorescent tubes 31G are switched on, and FIG. 7E is a spectrum diagram showing a spectral characteristic of light that is transmitted through a pixel corresponding to a blue color filter when the cold cathode fluorescent tubes 31RB are switched on.

FIG. 8 shows graphs for comparing wavelength spectra of phosphors used in an illumination device according to the first embodiment of the present invention with those of phosphors used in a conventional three-wavelength fluorescent tube.

FIG. 9 is a chromaticity diagram (NTSC ratio) showing color reproduction ranges in the CIE 1931 color system of a conventional liquid crystal display apparatus using a three-wavelength tube as a light source for a backlight and the liquid crystal display apparatus of this embodiment, respectively.

FIG. 10 is a block diagram showing a functional configuration of a liquid crystal display apparatus according to a second embodiment of the present invention.

FIG. 11 is a timing chart showing one example of timing for switching on each cold cathode fluorescent tube in the liquid crystal display apparatus according to the second embodiment of the present invention.

FIG. 12 is a timing chart showing another example of the timing for switching on each cold cathode fluorescent tube in the liquid crystal display apparatus according to the second embodiment of the present invention.

FIG. 13 is a timing chart showing still another example of the timing for switching on each cold cathode fluorescent tube in the liquid crystal display apparatus according to the second embodiment of the present invention.

FIG. 14 is a block diagram showing a functional configuration of a liquid crystal display apparatus according to a third embodiment of the present invention.

FIG. 15 is a block diagram showing an internal configuration of an interpolation data generating portion provided in the liquid crystal display apparatus according to the third embodiment.

FIG. 16 is a schematic diagram showing a structure of an active matrix substrate in a conventional active matrix type liquid crystal display element, in which each pixel is shown with a color of color filters corresponding thereto.

FIG. 17 is a spectrum diagram showing spectral transmission characteristics of color filters of three colors of RGB.

FIG. 18A is a spectrum diagram showing an emission spectrum of a three-wavelength tube, FIG. 18B is a spectrum diagram showing a spectral transmission characteristic of a red color filter in the case where this three-wavelength tube is used as a light source for a backlight, FIG. 18C is a spectral diagram showing a spectral transmission characteristic of a green color filter in the case where this three-wavelength tube is used as the light source for the backlight, and FIG. 18D is a spectrum diagram showing a spectral transmission characteristic of a blue color filter in the case where this three-wavelength tube is used as the light source for the backlight.

### DESCRIPTION OF THE INVENTION

An illumination device according to the present invention is an illumination device that is used as a backlight of a display apparatus and is characterized by including: a first light source that emits light of a first color; and a second light source that emits light of a second color complementary to the first color. In the device, each of the first light source and the second light source is a fluorescent tube having a cold cathode or a hot cathode, an amount of light emitted by the first light source is smaller than an amount of light emitted by the second light source, and the first light source and the second light source can be controlled so as to be switched on independently of each other.

According to this configuration, although the amount of light emitted by the second light source tends to be reduced because the second light source includes phosphors in a wide wavelength region in order to irradiate light of the second color complementary to the first color, it is possible to balance the amount of light emitted thereby with the amount of light emitted by the first light source, thereby allowing excellent white balance to be achieved.

Furthermore, it is preferable to have a configuration in which a plurality of the first light sources and a plurality of the second light sources are provided and arranged so as to alternate with each other one by one or in sets of a plural number of the first or second light sources.

According to this configuration, the occurrence of color irregularity due to the imbalance between the number of first light sources and the number of the second light sources is suppressed, thereby allowing a lamp image to be eliminated sufficiently.

Moreover, preferably, an amount of electric power supplied to the first light source is smaller than an amount of electric power supplied to the second light source, and an amount of electric current fed through the first light source is smaller than an amount of electric current fed through the second light source.

According to this configuration, it is possible to easily reduce the amount of irradiation light from the first light source while controlling it appropriately.

Furthermore, preferably, the first light source has an inner diameter larger than an inner diameter of the second light source.

According to this configuration, in a fluorescent tube, the distance between a phosphor and a positive column is increased, and thus light emission efficiency of a fluorescent tube that is the first light source can be reduced effectively.

In addition, preferably, a gas pressure inside the first light source is higher than a gas pressure inside the second light source.

According to this configuration, light emission efficiency of a fluorescent tube that is the first light source can be reduced.

In addition, preferably, the light of the first color has a spectrum principally in a wavelength region of green, and the light of the second color has a spectrum principally in wavelength regions of red and blue.

According to this configuration, an illumination device can be provided that allows deterioration in color purity of a displayed image to be suppressed effectively, which has been a problem resulting from color mixing due to a transmission characteristic of a green color filter of a display element overlapping the wavelength regions of blue light and red light.

Moreover, preferably, the first light source that emits light of the first color is a green fluorescent tube including a BAM:Mn phosphor, and the second light source that emits light of the second color is a blue-red mixed color fluorescent tube including a SCA phosphor and a GeM phosphor.

These types of phosphors have high color purity as phosphors of the respective colors of green, blue, and red and thus allow a wider range of color reproducibility to be achieved in an image display. Further, reducing the amount of light emitted by a BAM:Mn phosphor having a short life allows the life of a light source device to be increased.

In addition, it also is possible that the light of the first color has a spectrum principally in a wavelength region of blue, and the light of the second color has a spectrum principally in wavelength regions of red and green.

Furthermore, a display apparatus according to the present invention has a configuration including: a display element that includes: scanning lines and data lines that are arranged in a matrix form; a switching element that is connected to each of the scanning lines and a corresponding one of the data lines; a pixel portion that performs a gradation display in accordance with a data signal written from the corresponding one of the data lines when the switching element is brought to an ON state based on a signal of the each of the scanning lines; and color filters that are arranged so as to correspond to the pixel portions and include at least filters of three colors that exhibit a white color when mixed; an illumination device that outputs plane-shaped light to the display element and includes a first light source that emits light of a first color that is one of the three colors and a second light source that emits light of a second color complementary to the first color, and in which each of the first light source and the second light source is a fluorescent tube having a cold cathode or a hot cathode, and an amount of light emitted by the first light source is smaller than an amount of light emitted by the second light source; a scanning line driving portion that sequentially supplies a selection signal to each of the scanning lines at a cycle of half a time period in which one image is displayed in the display element; a data line driving portion that, at one of a first half and a latter half of the time period in which one image is displayed in the display element, supplies a data signal to be written into each in a group of pixel portions among the pixel portions that corresponds to the color filter of the first color to a corresponding one of the data lines, and at an other of the first half and the latter half of the time period, supplies a data signal to be written into each in groups of pixel portions among the pixel portions that correspond respectively to the color filters of two colors among the three colors other than the first color to a corresponding one of the data lines; and a light source driving portion that, at the one of the first half and the latter half of the time period in which one image is displayed in the display element, switches on the first light source while switching off the second light source, and at the other of the first half and the latter half of the time period, switches on the second light source while switching off the first light source.

Herein, “ . . . exhibit a white color when mixed” refers to a state of being seen to be white and nearly white to the human eye, which does not necessarily have to be a state of exhibiting perfect white by chromatic definition.

According to this configuration, at one of a first half and a latter half of a time period in which one image is displayed in the display element, a data signal to be written into each in a group of pixel portions among the pixel portions that corresponds to the color filter of the first color is supplied to a corresponding one of the data lines, and at an other of the first half and the latter half of the time period, a data signal to be written into each in groups of pixel portions among the pixel portions that correspond respectively to the color filters of two colors among the three colors other than the first color is supplied to a corresponding one of the data lines. Further, at the one of the first half and the latter half of the time period in which one image is displayed in the display element, the first light source is switched on while the second light source is switched off, and at the other of the first half and the latter half of the time period, the second light source is switched on while the first light source is switched off. Thus, even in the case where a spectral transmission curve of any one of color filters of the respective colors overlaps a wavelength region of another color, deterioration in color purity can be suppressed.

Furthermore, more preferably, in the display apparatus having the above-described configuration, the illumination device appropriately adopts any one of the above-described preferred modes of the illumination device according to the present invention, particularly in various configurations for balancing the amounts of light emitted by the first light source and the second light source, respectively. The reason for this is that, according to this configuration, white balance can be achieved easily in the display apparatus even in the case where the first light source that emits light of the first color and the second light source that emits light of the second color complementary to the first color are arranged in line, and the occurrence of light unevenness in the form of a lamp image in the light sources can be reduced effectively.

Furthermore, preferably, in the above-described configuration, at one of the first half and the latter half of the time period in which one image is displayed in the display element, the data line driving portion supplies a data signal for causing each in the groups of pixel portions among the pixel portions that correspond respectively to the color filters of two colors among the three colors other than the first color to perform a black gradation display to a corresponding one of the data lines, and at an other of the first half and the latter half of the time period in which one image is displayed in the display element, the data line driving portion supplies a data signal for causing each in the group of pixel portions among the pixel portions that corresponds to the color filter of the first color to perform a black gradation display to a corresponding one of the data lines.

This is preferable in that at each of a first half and a latter half of a time period in which one image is displayed in the display element, a pixel portion of a color that is not to be displayed is set so as to perform a black gradation display, and thus the generation of leakage light is prevented, thereby allowing further improved color purity to be obtained.

Furthermore, preferably, in the above-described configuration, in the illumination device, a plurality of the first light sources and a plurality of the second light sources are provided so that a longitudinal direction of the first and second light sources is parallel to an extending direction of the scanning lines, and at one of the first half and the latter half of the time period in which one image is displayed in the display element, the light source driving portion switches on the plurality of the first light sources successively in an order of arrangement so as to be synchronized with an application of the selection signal to each of the scanning lines, and at an other of the first half and the latter half of the time period in which one image is displayed in the display element, the light source driving portion switches on the plurality of the second light sources successively in an order of arrangement so as to be synchronized with the application of the selection signal to each, of the scanning lines.

This configuration is preferable in that with respect to the first light source and the second light source that are arranged in close proximity to each other, it prevents light from the first light source from being mixed with light from the second light source, thereby allowing further improved color purity to be obtained.

Furthermore, preferably, in the above-described configuration, an interpolation data generating portion further is provided that generates a data signal to be supplied to one of the data lines at the latter half of the time period in which one image is displayed in the display element by performing interpolation between a data signal to be supplied to the one of the data lines in said time period and a data signal to be supplied to the one of the data lines in a time period subsequent to said time period. This configuration is preferable in that, particularly, in the case where a moving picture is displayed, the occurrence of a color breaking phenomenon can be suppressed.

Hereinafter, the illumination device and the display apparatus of the present invention will be described by way of preferred embodiments with reference to the appended drawings. While being directed to an exemplary case where a television receiver including a transmission type liquid crystal display element is used as the display apparatus of the present invention, the following description is not intended to limit an application scope of the present invention. As the display element of the present invention, for example, a semi-transmission type liquid crystal display element can be used. Further, the applications of the display apparatus of the present invention are not limited only to a television receiver.

### First Embodiment

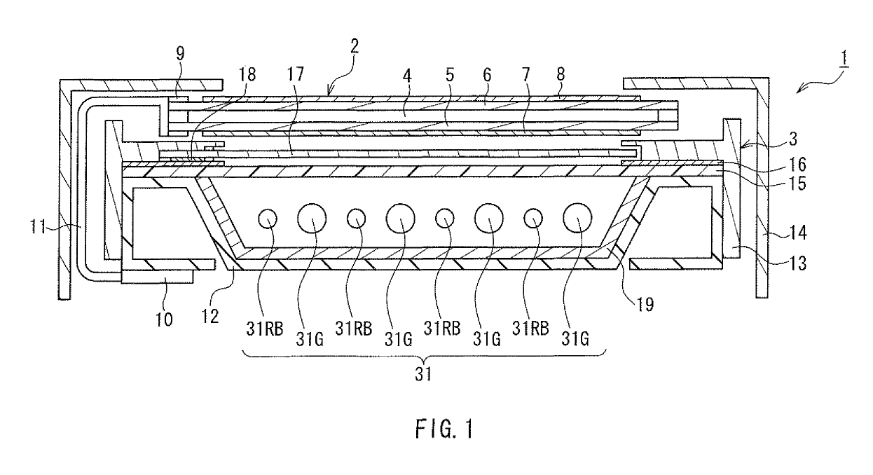

FIG. 1 is a schematic cross-sectional view illustrating an illumination device and a liquid crystal display apparatus including the same according to a first embodiment of the present invention. As shown in FIG. 1, in a liquid crystal display apparatus 1 of this embodiment, a liquid crystal panel 2 (display element) that is located with an upper side of FIG. 1 defined as a viewing side (display surface side) and a backlight device 3 (illumination device) that is disposed on a non-display surface side of the liquid crystal panel 2 (lower side of FIG. 1) and irradiates the liquid crystal panel 2 with plane-shaped light are provided.

The liquid crystal panel 2 includes a liquid crystal layer 4, a pair of transparent substrates 5 and 6 that sandwich the liquid crystal layer 4 therebetween, and polarizing plates 7 and 8 that are provided on the respective outer surfaces of the transparent substrates 5 and 6, respectively. Further, in the liquid crystal panel 2, a driver 9 (a gate driver or a source driver that will be described later) for driving the liquid crystal panel 2 and a drive circuit 10 that is connected to the driver 9 via a flexible printed board 11 are provided.

The liquid crystal panel 2 is an active matrix type liquid crystal panel and is configured so that supplying a scanning signal and a data signal respectively to scanning lines and data lines that are arranged in a matrix form allows the liquid crystal layer 4 to be driven on a pixel basis. Specifically, when a TFT (switching element) provided in the vicinity of each of intersections of the scanning lines and the data lines is brought to an ON state based on a signal of a corresponding one of the scanning lines, a data signal is written from a corresponding one of the data lines into a pixel electrode, and an alignment state of liquid crystal molecules changes in accordance with a potential level of the data signal, and thus each pixel performs a gradation display in accordance with a data signal. In other words, in the liquid crystal panel 2, a polarization state of light made incident from the backlight device 3 through the polarizing plate 7 is modulated by the liquid crystal layer 4, and the amount of light passing through the polarizing plate 8 is controlled, and thus a desired image is displayed.

In the backlight device 3, a bottomed case 12 that is open on the liquid crystal panel 2 side and a frame-shaped frame 13 that is located on the liquid crystal panel 2 side of the case 12 are provided. Further, the case 12 and the frame 13 are made of a metal or a synthetic resin and are held within a bezel 14 having an L shape in cross section with the liquid crystal panel 2 located above the frame 13. The backlight device 3 thus is combined with the liquid crystal panel 2, and the backlight device 3 and the liquid crystal panel 2 are integrated as the liquid crystal display apparatus 1 of a transmission type in which illumination light from the backlight device 3 is made incident on the liquid crystal panel 2.

Furthermore, the backlight device 3 includes a diffusing plate 15 that is located so as to cover an opening of the case 12, an optical sheet 17 that is located above the diffusing plate 15 on the liquid crystal panel 2 side, and a reflecting sheet 19 that is provided on an inner surface of the case 12. Further, in the backlight device 3, a plural number of cold cathode fluorescent tubes 31, each having a cold cathode as a cathode, are provided above the reflecting sheet 19, and light from the cold cathode fluorescent tubes 31 is irradiated toward the liquid crystal panel 2 as plane-shaped light. Although FIG. 1 shows, for the sake of simplicity, a configuration including eight cold cathode fluorescent tubes 31, the number of the cold cathode fluorescent tubes 31 is not limited thereto.

The plural number of cold cathode fluorescent tubes 31 include a green cold cathode fluorescent tube 31G as a green fluorescent tube in which a green phosphor is sealed so that an emission spectrum of the cold cathode fluorescent tube 31G has a peak in a wavelength region of green and a magenta cold cathode fluorescent tube 31RB as a blue-red mixed color fluorescent tube in which red and blue phosphors are sealed so that an emission spectrum of the cold cathode fluorescent tube 31RB is of a pattern of a magenta (red+blue) color complementary to green.

Herein, in the backlight device 3 in the present invention, the amount of light emitted by the green cold cathode fluorescent tube 31G, which is the first light source and emits green light that is light of the first color, is set to be smaller than the amount of light emitted by the magenta cold cathode fluorescent tube 31RB, which is the second light source and emits magenta light that is light of the second color complementary to the first color.

The following describes the reason for the above. That is, normally, compared with the green cold cathode fluorescent tube 31G that emits monochromatic green light, the magenta cold cathode fluorescent tube 31RB emits a lower amount of light since it has to emit magenta light obtained by mixing light of blue and red, which are complementary colors. In such a state where the amounts of light emitted by the light sources are unbalanced, it becomes difficult to achieve white balance in a displayed image. Further, if, as a way to solve this, the number of the magenta cold cathode fluorescent tubes 31RB that emit a smaller amount of light is made larger than the number of the green cold cathode fluorescent tubes 31G, light unevenness attributable to the difference in color between the light sources becomes more likely to be perceived, and the application of the later-described method in which the light sources are switched on while being scanned sequentially becomes difficult. These problems can be solved more effectively by setting the amount of light emitted by the green cold cathode fluorescent tube 31G to be smaller while setting the number of the green cold cathode fluorescent tubes 31G and the number of the magenta cold cathode fluorescent tubes 31RB to be equal.

As a measure to achieve this, for example, in FIG. 1, the green cold cathode fluorescent tubes 31G are made to have inner and outer diameters, which are both larger than those of the magenta cold cathode fluorescent tubes 31RB. The green cold cathode fluorescent tubes 31G and the magenta cold cathode fluorescent tubes 31RB will be detailed later.

The green cold cathode fluorescent tubes 31G and the magenta cold cathode fluorescent tubes 31RB are arranged so that a longitudinal direction thereof is parallel to an extending direction of the scanning lines of the liquid crystal panel 2. Although FIG. 1 shows an example in which the green cold cathode fluorescent tubes 31G and the magenta cold cathode fluorescent tubes 31RB are arranged so as to alternate with each other one by one, the green cold cathode fluorescent tubes 31G and the magenta cold cathode fluorescent tubes 31RB may have a configuration in which they alternate with each other in sets of a plural number (for example, two) of the cold cathode fluorescent tubes 31G or 31RB.

The number of the cold cathode fluorescent tubes 31 can be determined appropriately in accordance with the screen size of the liquid crystal display apparatus 1, the brightness of each, of the fluorescent tubes, and the like. In one example, in the case where the liquid crystal display apparatus 1 has a screen size of a so-called 37V type, it is preferable to have a configuration including about 18 cold cathode fluorescent tubes in total composed of nine green cold cathode fluorescent tubes 31G and nine magenta cold cathode fluorescent tubes 31RB.

The diffusing plate 15 that is made of, for example, a synthetic resin or a glass material diffuses light from the cold cathode fluorescent tubes 31 (containing light reflected off the reflecting sheet 19) and outputs it to the optical sheet 17 side. Further, the four sides of the diffusing plate 15 are mounted on a frame-shaped surface provided on an upper side of the case 12, and the diffusing plate 15 is incorporated in the backlight device 3 while being sandwiched between said surface of the case 12 and an inner surface of the frame 13 via a pressure member 16 that is deformable The optical sheet 17 includes a condensing sheet formed of, for example, a synthetic resin film and is configured so as to increase the luminance of illumination light from the backlight device 3 to the liquid crystal panel 2. Further, on the optical sheet 17, optical sheet materials such as a prism sheet, a diffusing sheet, a polarizing sheet and the like are laminated appropriately as required for the purpose of, for example, improving display quality on a display surface of the liquid crystal panel 2. The optical sheet 17 is configured so as to convert light outputted from the diffusing plate 15 into plane-shaped light having a uniform luminance not lower than a predetermined luminance (for example, 10,000 cd/m²) and make it incident as illumination light on the liquid crystal panel 2. In addition to the above-described configuration, for example, optical members such as a diffusing sheet and the like for adjusting a viewing angle of the liquid crystal panel 2 may be laminated appropriately above the liquid crystal panel 2 (on the display surface side).

The reflecting sheet 19 is formed of, for example, a thin film of a metal having a high light reflectance such as aluminum, silver or the like and functions as a reflecting plate that reflects light from the cold cathode fluorescent tubes 31 toward the diffusing plate 15. Thus, in the backlight device 3, the use efficiency and luminance at the diffusing plate 15 of light from the cold cathode fluorescent tubes 31 can be increased. In place of the above-described metal thin film, a reflecting sheet material made of a synthetic resin may be used, or alternatively, for example, a coating of a white paint or the like having a high light reflectance may be applied to the inner surface of the case 12 so that said inner surface functions as a reflecting plate.

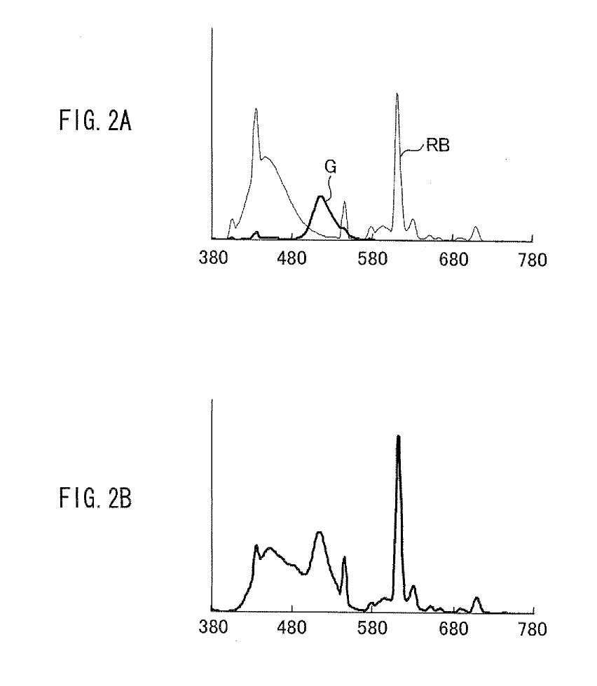

FIG. 2 shows graphs of irradiation spectrum intensities of the first light source and the second light source, which are used suitably in the backlight device 3 in the display apparatus of the present invention.

In FIG. 2A, a bold line indicates an irradiation spectrum intensity of the green cold cathode fluorescent tube 31G that irradiates green light as the first light source, and a thin line indicates an irradiation spectrum intensity of the magenta cold cathode fluorescent tube 31RB that irradiates light of magenta complementary to green as the second light source. In this embodiment, a BAM:Mn phosphor (composition: BaMgAl₁₀O₁₇: Eu, Mn, peak wavelength=516 nm, NP-108 [product name] manufactured by Nichia Corporation) is used in the green cold cathode fluorescent tube 31G, and a SCA phosphor (composition: Sr₅(PO₄)₃Cl:Eu, peak wavelength=447 nm, NP-103 [product name] manufactured by Nichia Corporation) as a blue phosphor and a GeM phosphor (composition: 3.5 MgO·0.5 MgF₂·GeO₂:Mn, peak wavelength=658 nm, NP-320 [product name] manufactured by Nichia Corporation) as a red phosphor are used in the magenta cold cathode fluorescent tube.

FIG. 2A shows a state that is brought about when, in order to make the amount of irradiation light of the green cold cathode fluorescent tube 31G smaller compared with the amount of irradiation light of the magenta cold cathode fluorescent tube 31RB, the amount of electric power to be supplied is adjusted so that the green cold cathode fluorescent tube 31G is supplied with electric power in an amount reduced to 11%. It is understood that, as a result of this, compared with the magenta cold cathode fluorescent tube 31RB supplied with electric power in an amount of 100%, the green cold cathode fluorescent tube 31G has a lower spectrum intensity.

FIG. 2B shows the result of a simulation performed to see a spectrum intensity of irradiation light from the green cold cathode fluorescent tube 31G and the magenta cold cathode fluorescent tube 31RB on the liquid crystal panel as the display element, where as in the state shown in FIG. 2A, the amount of electric power supplied to the green cold cathode fluorescent tube 31G is set to 11% and the amount of electric power supplied to the magenta cold cathode fluorescent tube 31RB is set to 100%.

As shown in FIG. 2B, it is understood that the spectrum intensity of irradiation light from the backlight device 3 according to this embodiment has well-balanced peaks in the respective regions of RGB, and thus white balance can be achieved easily in a displayed image on the liquid crystal panel, thereby allowing a display of an image with an excellent color tone.

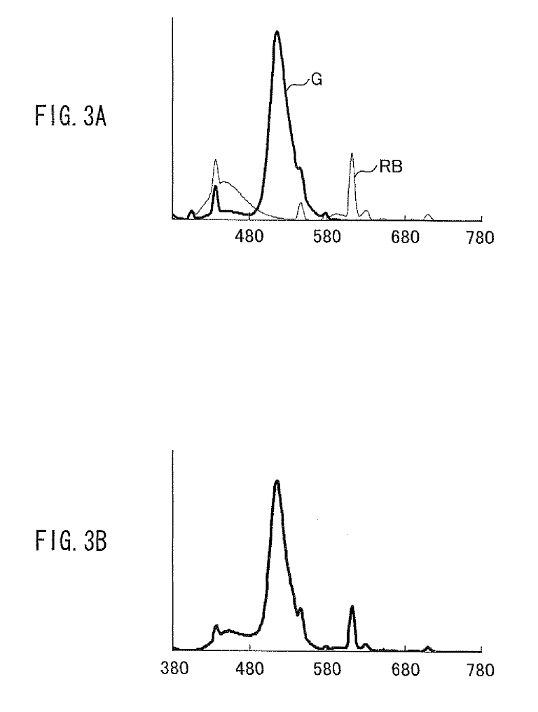

In contrast, FIG. 3 shows a comparative example exhibiting spectrum intensities in the case where the amount of electric power supplied to the green cold cathode fluorescent tube 31G and the amount of electric power supplied to the magenta cold cathode fluorescent tube 31RB are both set to 100%. The types of phosphors used in these fluorescent tubes, respectively, are the same as used in the example shown in FIG. 2A.

In FIG. 3A, a bold line indicates an irradiation spectrum intensity of the green cold cathode fluorescent tube 31G as the first light source, and a thin line indicates an irradiation spectrum intensity of the magenta cold cathode fluorescent tube 31RB. It is understood that the green cold cathode fluorescent tube 31G in which the monochrome phosphor is applied has an extremely high irradiation spectrum intensity compared with the spectrum intensity of the magenta cold cathode fluorescent tube 31RB in which the blue phosphor and the red phosphor are applied in an mixed state. It is understood that as a result of this, also in FIG. 3B showing the spectrum intensity on the liquid crystal panel as the display element, light in the green region has an extremely high peak, bringing about a state where white balance hardly can be achieved.

In the backlight device according to the present invention, based on the above-described examination results, the amount of light emitted by the green cold cathode fluorescent tube, which is the first light source that emits the first light, is set to be smaller than the amount of light emitted by the magenta cold cathode fluorescent tube, which is the second light source that emits light of the second color complementary to light of the first color.

In order to achieve this, specifically, a first possible measure is to set so that the amount of electric power supplied to the green cold cathode fluorescent tube is smaller than the amount of electric power supplied to the magenta cold cathode fluorescent tube as in the above-described embodiment shown in FIG. 2. In this case, for example, in accordance with the above-described simulation result, the amount of electric power supplied to the green cold cathode fluorescent tube is set to about 11% and the amount of electric power supplied to the magenta cold cathode fluorescent tube is set to 100%, and thus a backlight device can be obtained that is capable of irradiating a liquid crystal panel with irradiation light in which a balance among three colors of RGB is attained.

Another possible measure is to set so that the amount of electric current fed through the green cold cathode fluorescent tube is smaller than the amount of electric current fed through the magenta cold cathode fluorescent tube. In this case, for example, the amount of electric current fed to the green cold cathode fluorescent tube is set to 3.0 mA and the amount of electric current fed to the magenta cold cathode fluorescent tube is set to 6.0 mA, and thus a balance among three colors of RGB can be attained in irradiation light from the backlight device. In adjusting the amount of light emitted by a light source by means of the amount of electric current, variations may occur depending on, for example, the condition of each fluorescent tube, and thus in this embodiment, it is preferable to make an adjustment appropriately so that the amount of electric current fed to the green cold cathode fluorescent tube is in a range of 3.0 to 5.0 mA, and the amount of electric current fed to the magenta cold cathode fluorescent tube is in a range of 5.0 to 7.5 mA.

Another possible method of making the amount of light emitted b_{y} the green cold cathode fluorescent tube smaller than the amount of light emitted by the magenta cold cathode fluorescent tube is to set the inner diameter of the green cold cathode fluorescent tube to be larger than the inner diameter of the magenta cold cathode fluorescent tube. For example, the inner diameter of the green cold cathode fluorescent tube is set to 3 to 4 mm and the inner diameter of the magenta cold cathode fluorescent tube is set to 2.4 to 3 mm, which is an inner diameter value used typically for cold cathode fluorescent tubes for a backlight, and thus in the green cold cathode fluorescent tube, the distance between a positive column and a phosphor is increased, thereby allowing the amount of emission light thereof can be reduced. From the viewpoint of light emission efficiency of a fluorescent tube, the amount of light emitted by the fluorescent tube can be adjusted by changing its inner diameter alone. However, due to the limitations of manufacturing processes and the like, it is often difficult to change the thickness of a glass tube constituting the fluorescent tube, resulting in the general case in which the outer diameter also is changed when the inner diameter is changed.

Furthermore, still another possible method of making the amount of light emitted by the green cold cathode fluorescent tube smaller than the amount of light emitted by the magenta cold cathode fluorescent tube is to set the gas pressure inside the green cold cathode fluorescent tube to be higher than the gas pressure inside the magenta cold cathode fluorescent tube. This is because the increase in gas pressure inside a fluorescent tube causes a positive column generated inside the fluorescent tube to have a thinner diameter, and thus light emission efficiency is reduced. In this case, for example, the pressure inside the green cold cathode fluorescent tube is set to 80 to 90 Torr and the pressure inside the magenta cold cathode fluorescent tube is set to about 60 Torr, which is a normal pressure value therein, and thus a balance among three colors of RGB can be attained.

The foregoing has described the specific measures to make the amount of light emitted by the green cold cathode fluorescent tube 31G smaller than the amount of light emitted by the magenta cold cathode fluorescent tube 31RB. These measures can be used alone, and it also is possible to adopt two or more of these redundantly.

It is known that, while having high color purity, a BAM:Mn phosphor used as the green phosphor in this embodiment has a shorter life compared with those of other types of phosphors. Through the adoption of the method in which the green cold cathode fluorescent tube is used so as to be supplied with a reduced amount of electric power as described in this embodiment, it also becomes possible to cancel out the disadvantage that a BAM:Mn phosphor has a short life and further to allow the backlight device to have a life of 60,000 hours or longer.

With respect to the light sources included in the backlight device 3 according to the present invention, the foregoing has described the green cold cathode-fluorescent tube and the magenta cold cathode fluorescent tube as examples of the green fluorescent tube as the first light source and the blue-red mixed color fluorescent tube as the second light source. However, the present invention is applicable also to the case of using a hot cathode fluorescent tube having a hot cathode without being limited to the case of using a cold cathode fluorescent tube. Also, as for phosphors applied to fluorescent tubes, the phosphors used in the above-described embodiment are merely preferred examples and are not intended to limit the application scope of the present invention thereto.

Moreover, although the foregoing description has been made using a green light source as the first light source and a magenta light source as the second light source of a color complementary to green, colors of light sources also are not limited thereto. For example, it also is possible to use a blue light source as the first light source and a yellow (mixed color of green and red) light source as the second light source of a color complementary to blue, allowing the present invention to be applied suitably.

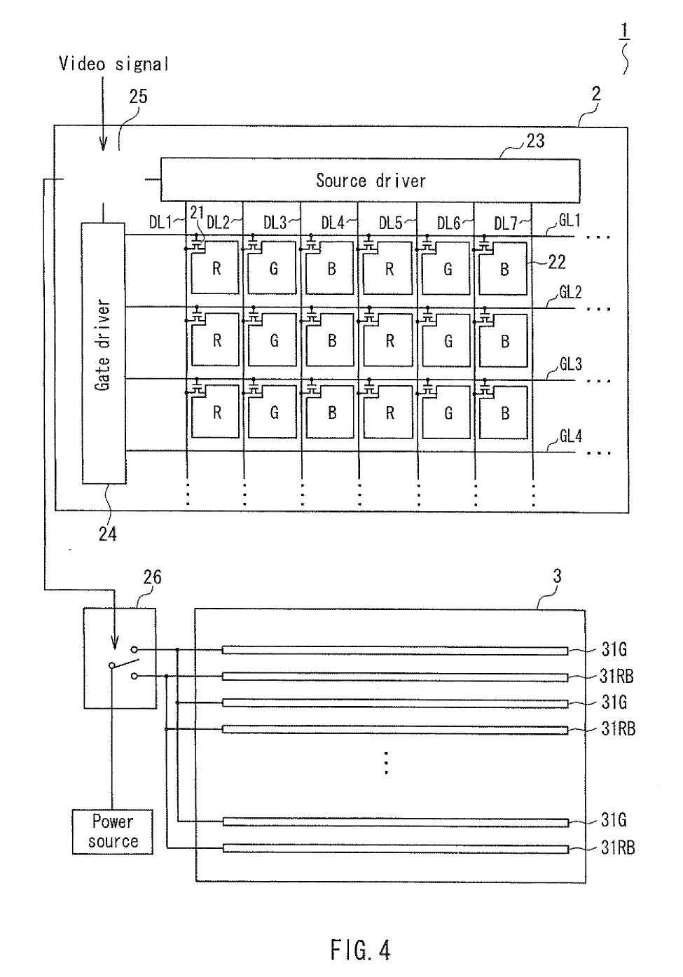

In the following, the configurations of the liquid crystal panel 2 and the backlight device 3 in the liquid crystal display apparatus 1 and methods of driving them will be described in more detail with reference to FIG. 4. FIG. 4 is a diagram schematically showing a functional relationship between the liquid crystal panel 2 and the backlight device 3 but is not intended to faithfully represent the physical sizes of the liquid crystal panel 2 and the backlight device 3.

As described above, the liquid crystal panel 2 is an active matrix type liquid crystal display element, and as shown in FIG. 4, it includes scanning lines GL and data lines DL that are arranged in a matrix form, a TFT 21 that is disposed at each of intersections of the scanning lines GL and the data lines DL, a pixel electrode 22 that is connected to a drain electrode of the TFT 21, a gate driver 24 that sequentially supplies a selection signal to the scanning lines GL, a source driver 23 that supplies a data signal to each of the data lines, and a controller 25 that supplies a dock signal, a timing signal and the like to the source driver 23, the gate driver 24 and the like.

Furthermore, the liquid crystal display apparatus 1 includes a switch circuit 26 that controls switching on/off of the green cold cathode fluorescent tubes 31G and the magenta cold cathode fluorescent tubes 31RB of the backlight device 3 in accordance with, for example, a timing signal supplied from the controller 25. The switch circuit 26 controls switching on/off of the cold cathode fluorescent tubes 31G and 31RB through ON/OFF of voltage supply from an alternating-current power source or the like to the cold cathode fluorescent tubes 31G and 31IRB. In this embodiment, the switch circuit 26 is configured so that ON/OFF of all the plural number of the green cold cathode fluorescent tubes 31G are controlled simultaneously, and ON/OFF of all the plural number of the magenta cold cathode fluorescent tubes 31RB also are controlled simultaneously.

The configurations of the drivers and controller shown in FIG. 4 are merely illustrative, and modes of mounting these driving system circuits are arbitrary. For example, these driving system circuits may be provided so that at least part of them is formed monolithically on an active matrix substrate, also may be mounted as semiconductor chips on a substrate, or alternatively, may be connected as external circuits of the active matrix substrate. Further, the switch circuit 26 may be provided on either of the liquid crystal panel 2 and the backlight device 3.

On an opposing substrate (not shown) opposed to this active matrix substrate, color filter layers of three colors of RGB are formed in stripes. In FIG. 4, the colors of color filters corresponding respectively to pixels are denoted by characters “R”, “G”, and “B”. Thus, as shown in FIG. 4, all of pixels in one column connected commonly to each of the data lines DL display one of the colors of RGB. For example, in FIG. 4, all of pixels connected to the data line DL1 display red (R). Although the color filters described herein are in a stripe arrangement, other types of arrangements such as a delta arrangement and the like also may be adopted.

In the liquid crystal panel 2 configured as above, when a gate pulse (selection signal) having a predetermined voltage is applied sequentially to the scanning lines GL1, GL2, GL3, GL4, . . . , each of the TFTs 21 connected to one of the scanning lines GL, to which the gate pulse has just been applied, is brought to an ON state, and a value of a gradation voltage that has been applied to a corresponding one of the data lines DL at that point in time is written into the each of the TFTs 21. Consequently, a potential of the pixel electrode 22 connected to a drain electrode of the each of the TFTs 21 becomes equal to the value of the gradation voltage of the corresponding one of the data lines DL. As a result of this, an alignment of liquid crystals interposed between the pixel electrode 22 and an opposing electrode changes in accordance with the value of the gradation voltage, and thus a gradation display of said pixel is realized. On the other hand, during a time period in which a non-selective voltage is applied to the scanning lines GL, the TFTs 21 are brought to an OFF state, so that the potential of the pixel electrode 22 is maintained at a value of a potential applied thereto at the time of writing.

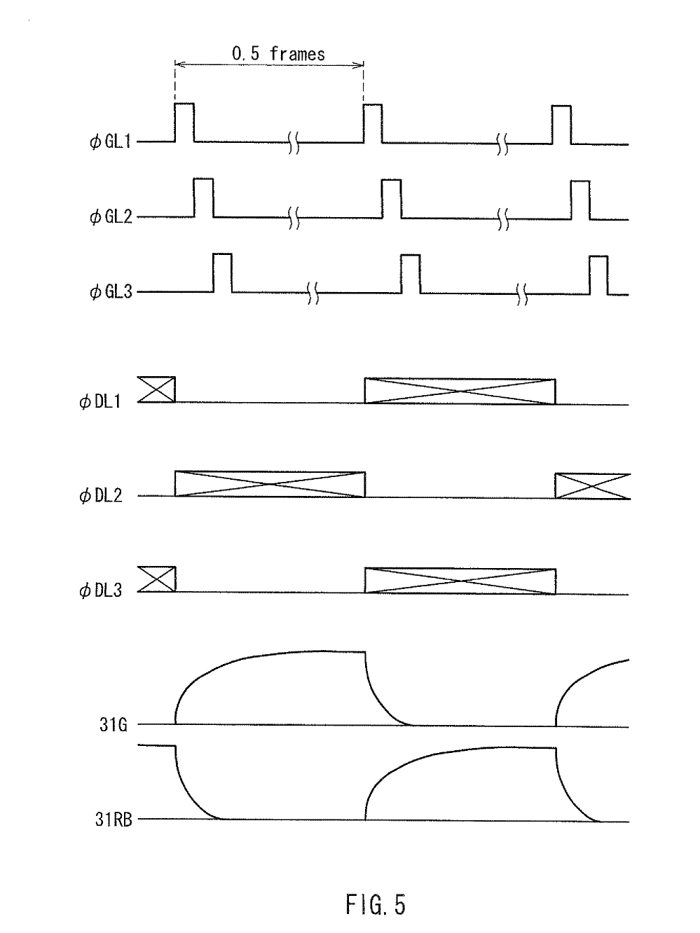

In the liquid crystal display apparatus 1 of this embodiment, which is configured as above, as shown in FIG. 5, the gate driver 24 applies a gate pulse to each of the scanning lines GL at a cycle of ½ of a time period (one frame time period) in which one image is displayed in the liquid crystal panel 2. Then, at a first half of this one frame time period, the switch circuit 26 switches on the green cold cathode fluorescent tubes 31G that emit green light while switching off the magenta cold cathode fluorescent tubes 31RB. Further, at a latter half of one frame time period, the switch circuit 26 switches off the green cold cathode fluorescent tubes 31G that emit green light while switching on the magenta cold cathode fluorescent tubes 31RB. In FIG. 5, the first and second graphs from the bottom show the amounts of light emitted by the cold cathode fluorescent tubes 31G and 31RB, respectively.

Furthermore, at the first half of one frame time period, the source driver 23 supplies a data signal to be applied to a green pixel to each of the data lines DL2, DL5, DL8, . . . that are connected to a group of pixel electrodes 22 among the pixel electrodes 22 that corresponds to the green color filter. Thus, at the first half of one frame time period, only a portion constituted of green pixels in one image is displayed.

Furthermore, at the latter half of one frame time period, the source driver 23 supplies a data signal to be applied to a red pixel to each of the data lines DL1, DL4, DL7, . . . that are connected to a group of pixel electrodes 22 among the pixel electrodes 22 that corresponds to the red color filter, and supplies a data signal to be applied to a blue pixel to each of the data lines DL3, DL6, DL9, . . . that are connected to a group of pixel electrodes 22 among the pixel electrodes 22 that corresponds to the blue color filter. Thus, at the latter half of one frame time period, only portions constituted of red pixels and blue pixels in one image are displayed.

For example, in the case where a data signal is a video signal according to the NTSC standards, the refreshing rate is 60 Hz and the length of one frame time period is 16.7 milliseconds. Therefore, in the case where at a first half of one frame time period, only a portion constituted of green pixels is displayed, and at a latter half thereof, portions constituted of red pixels and blue pixels are displayed as described above, due to a residual image effect, a resulting image is recognized to the human eye as an image of mixed colors of the three primary colors.

At the first half of one frame time period, during lighting of the green cold cathode fluorescent tubes 31G that emit green light, a data signal supplied to each of the data lines DL1, DL4, DL7, . . . that are connected to the group of pixel electrodes 22 among the pixel electrodes 22 that corresponds to the red color filter and a data signal supplied to each of the data lines DL3, DL6, DL9, . . . that are connected to the group of pixel electrodes 22 among the pixel electrodes 22 that corresponds to the blue color filter may be maintained at a value of a potential applied in an immediately preceding frame or may have a predetermined potential value. However, it is preferable that these data signals have such a potential value as to cause a black gradation display. This is preferable because a black gradation display allows unwanted leakage light from a pixel portion to be blocked. The following describes reasons why leakage light as described above is generated.

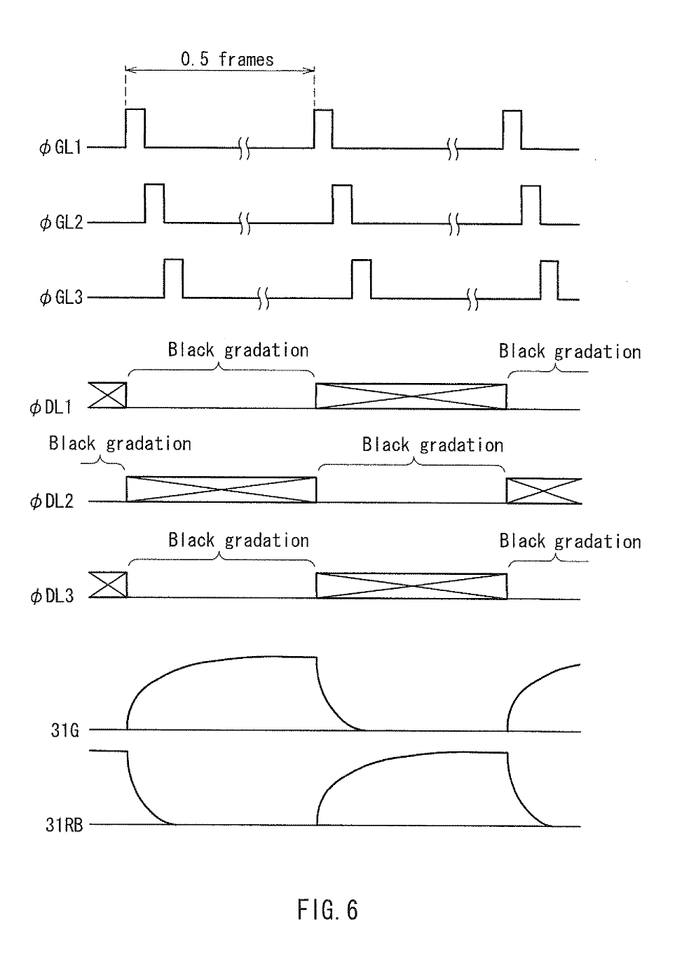

One possible reason is that an ON/OFF signal of a drive circuit of the cold cathode fluorescent tubes is delayed or dull. That is, when the switch circuit 26 is controlled so that switching on/off is switched depending on whether the switching is performed at a first half or a latter half of one frame time period, if an ON/OFF signal is delayed or dull, there occurs a deviation of timing at which the cold cathode fluorescent tubes actually are switched ON/OFF. Because of this, for example, at an early stage of a first half of a frame, due to light from the magenta cold cathode fluorescent tubes 311(13 that are supposed to have been switched off, leakage light from the red and blue pixels may be generated, though in a small amount. Further, reasons other than the above-described reason include an ON/OFF delay of the cold cathode fluorescent tubes. Specifically, a cold cathode fluorescent tube has a characteristic that the amount of light emitted thereby does not immediately change in response to the control of switching on/off. For example, as shown in FIG. 6, when the switch circuit 26 is controlled so that switching on/off is switched depending on whether the switching is performed at a first half or a latter half of one frame time period, with respect to either of the cold cathode fluorescent tubes 31G and 31RB, which is being switched off, the amount of light emitted thereby does not become zero immediately after switching by means of the switch circuit 26. Because of this, for example, at an early stage of a first half of a frame, due to light from the magenta cold cathode fluorescent tubes 31RB that are supposed to have been switched off, leakage light from the red and blue pixels may be generated, though in a small amount.

In such a case, as shown in FIG. 6, at a first half of one frame time period, a data signal having such a potential value as to cause a black gradation display is applied to each of the data lines DL1, DL4, DL7, . . . that are connected to the group of pixel electrodes 22 among the pixel electrodes 22 that corresponds to the red color filter and to each of the data lines DL3, DL6, DL9, . . . that are connected to the group of pixel electrodes 22 among the pixel electrodes 22 that corresponds to the blue color filter, and thus the generation of leakage light as described above can be prevented, thereby allowing further improved color purity to be obtained. For the same reason, it is preferable that, at a latter half of one frame time period, a data signal having such a potential value as to cause a black gradation display is supplied to each of the data lines DL2, DL5, DL8, . . . that are connected to the group of pixel electrodes 22 among the pixel electrodes 22 that corresponds to the green color filter.

Herein, the description is directed to an effect provided by the configuration of this embodiment in comparison with the conventional technique.

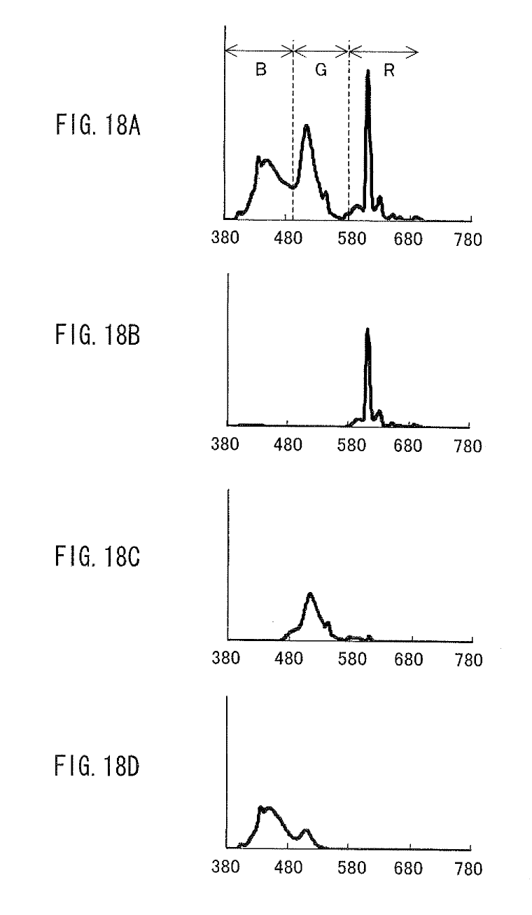

As shown in FIGS. 18C and 18D, the conventional configuration using a three-wavelength tube or a four-wavelength tube as a light source for a backlight has presented a problem that a blue component is mixed into a pixel that is to be displayed in green, and a green component is mixed into a pixel that is to be displayed in blue. This is caused by the fact that a spectral transmission curve of a blue color filter partially overlaps a wavelength band region of green and a spectral transmission curve of a green color filter partially overlaps a wavelength band region of blue. Particularly, the human eye has high sensitivity to a wavelength component of green, so that an adverse effect exerted on image quality when a green component is mixed into a blue pixel has been recognized to be considerable.

With respect to this problem, in the configuration of this embodiment, when displaying pixels corresponding to the blue color filter, only the magenta cold cathode fluorescent tubes 31RB that do not have a wavelength component of green are switched on, and thus even though a spectral transmission curve of a blue color filter partially overlaps a wavelength band region of green, there is no possibility that an emission spectrum occurs in the wavelength region of green, thereby preventing the occurrence of color mixing. This achieves an improvement in color purity.

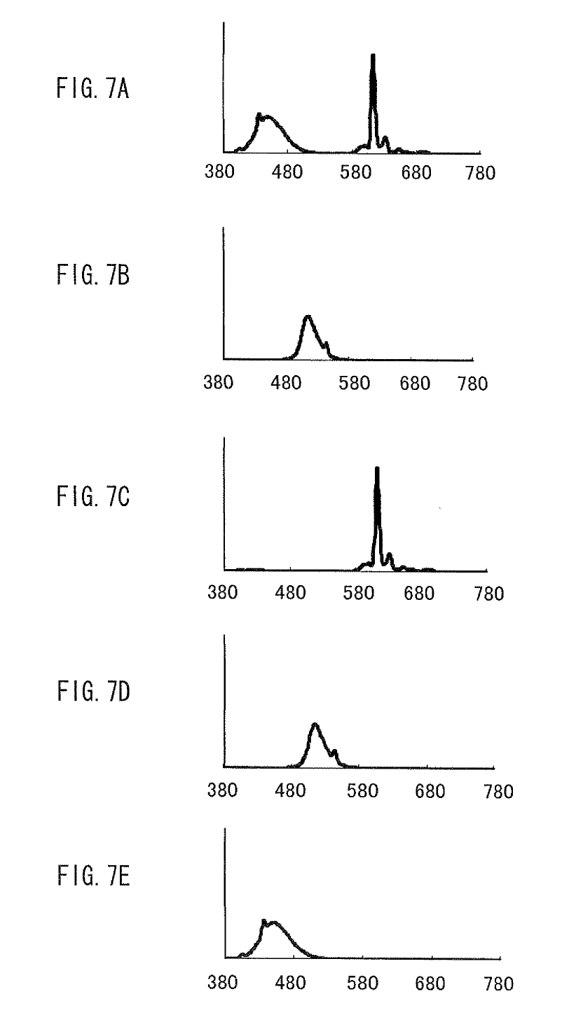

Particularly, by the above-described configuration in which the red and blue pixels are set so as to perform a black gradation display during a time period (first half of one frame) in which the green pixels are displayed and the green pixels are set so as to perform a black gradation display during a time period (latter half of one frame) in which the red and blue pixels are displayed, red, green, and blue can be separated completely without being mixed as shown in FIGS. 7C to 7E. FIG. 7A is a spectrum diagram showing a spectral characteristic of the magenta cold cathode fluorescent tube 31RB, and FIG. 7B is a spectrum diagram showing a spectral characteristic of the green cold cathode fluorescent tube 31G. FIG. 7C is a spectrum diagram showing a spectral characteristic of light that is transmitted through a pixel corresponding to the red color filter when the magenta cold cathode fluorescent tubes 31RB are switched on. FIG. 7D is a spectrum diagram showing a spectral characteristic of light that is transmitted through a pixel corresponding to the green color filter when the green cold cathode fluorescent tubes 31G are switched on. FIG. 7E is a spectrum diagram showing a spectral characteristic of light that is transmitted through a pixel corresponding to the blue color filter when the magenta cold cathode fluorescent tubes 31RB are switched on.

Herein, a comparison is made between emission spectra of a blue phosphor, a green phosphor, and a red phosphor used for phosphors in the conventional three-wavelength tube and emission spectra of the green phosphor used in the green cold cathode fluorescent tube and the blue and red phosphors used in the magenta cold cathode fluorescent tube, which are shown in this embodiment.

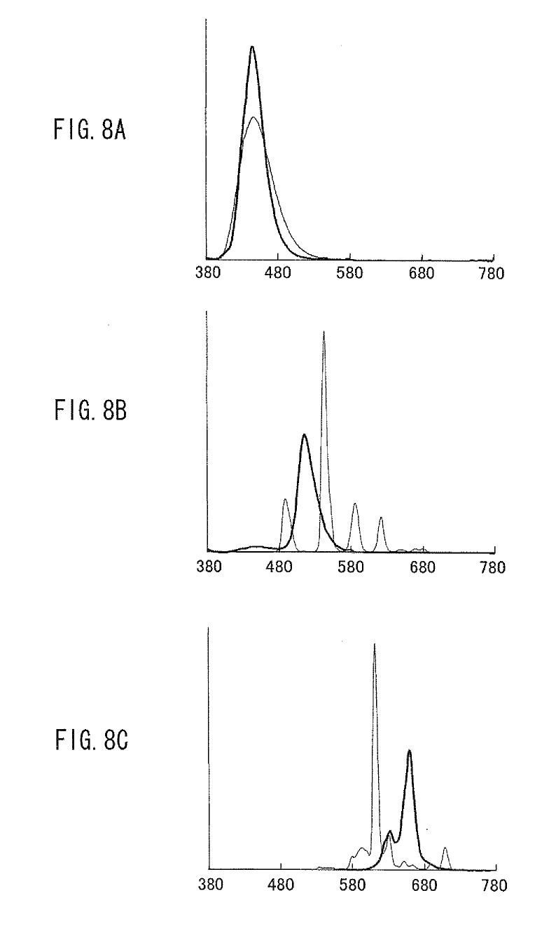

FIG. 8A superimposedly shows emission spectra of a SCA phosphor that is the blue phosphor used in this embodiment and a BAM phosphor (composition: BaMgAl₁₀O₁₇:Eu, peak wavelength=450 nm, NP-107 [product name] manufactured by Nichia Corporation) used in the conventional three-wavelength fluorescent tube. In FIG. 8A, a bold line indicates the spectrum of the SCA phosphor shown in this embodiment, and a thin line indicates the emission spectrum of the BAM phosphor.

Furthermore, FIG. 8B shows emission spectra of a BAM:Mn phosphor that is the green phosphor used in this embodiment and a Lap phosphor (composition: LaPO₄:Ce, Tb, peak wavelength=540 nm, NP-220 [product name] manufactured by Nichia Corporation) used in the conventional three-wavelength fluorescent tube. In FIG. 8B, a bold line indicates the emission spectrum of the BAM:Mn phosphor shown in this embodiment, and a thin line indicates the Lap phosphor.

Further, FIG. 8C shows emission spectra of a GeM phosphor that is the red phosphor used in this embodiment and a YOX phosphor (composition: Y₂O₃:Eu, peak wavelength=611 nm, NP-340 [product name] manufactured by Nichia Corporation) used in the conventional three-wavelength fluorescent tube. In FIG. 8C, a bold line indicates the spectrum of the GeM phosphor shown in this embodiment, and a thin line indicates the YOX phosphor.

FIGS. 8A to 8C show that each of the phosphors of the respective colors used in this embodiment exhibits a more conspicuous wavelength peak and thus has higher color purity. Particularly, in the present invention, for example, a problem from a practical application standpoint that a BAM:Mn phosphor, which is a green phosphor, has a short life is solved by reducing the amount of electric power supplied to the green fluorescent tube, thus allowing the BAM:Mn phosphor to be in practical use for a longer time, so that the use of phosphors having increased color purity is enabled.

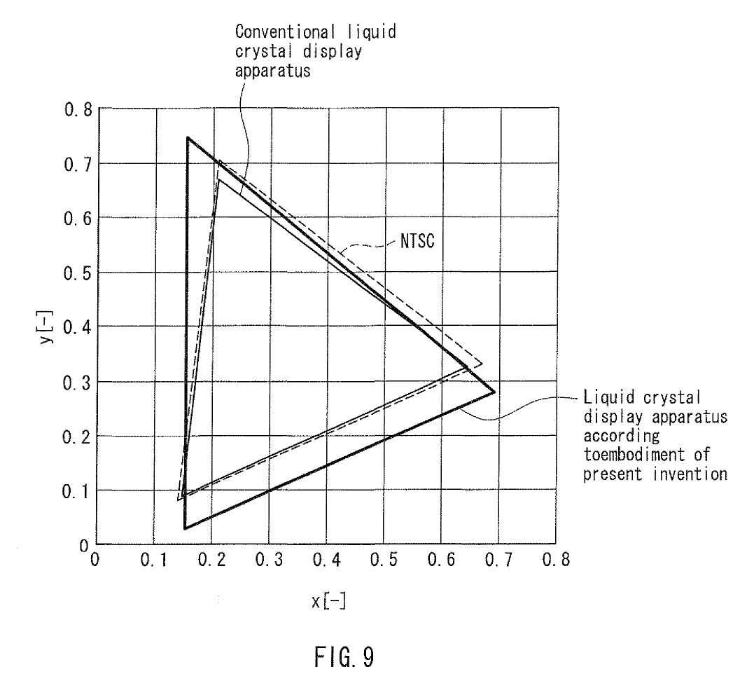

FIG. 9 is a chromaticity diagram (NTSC ratio) showing color reproduction ranges in the CIE 1931 color system of the above-described conventional liquid crystal display apparatus using a three-wavelength tube as a light source for a backlight and the liquid crystal display apparatus of this embodiment, respectively.

It is understood that, in this embodiment, phosphors of the respective three colors of blue, green, and red that have high color purity can be used as described above, and thus compared with the conventional liquid crystal display apparatus, the liquid crystal display apparatus of this embodiment exhibits a considerably increased color reproduction range. As for a NTSC ratio, the conventional liquid crystal display apparatus had a ratio of 87.4%, whereas the liquid crystal display apparatus of this embodiment had a ratio of 121.3%.

As discussed in the foregoing description, according to the liquid crystal display apparatus of this embodiment, compared with a conventional liquid crystal display apparatus using a three-wavelength tube or a four-wavelength tube as a light source for a backlight, improved color purity can be obtained. Further, although a supply of a gate pulse at a cycle of 0.5 frames increases a refreshing rate of a screen, since liquid crystals have a response speed that can conform to the refreshing rate at a frame rate of NTSC, PAL or the like, the liquid crystal display apparatus of this embodiment still can be realized sufficiently.

### Second Embodiment

The following describes an illumination device and a liquid crystal display apparatus including the same according to a second embodiment of the present invention. In the following description, configurations having functions similar to those of the configurations described in the first embodiment are denoted by the same reference characters, and detailed descriptions thereof are omitted.

The liquid crystal display apparatus according to this embodiment is different from the liquid crystal display apparatus according to the first embodiment in that cold cathode fluorescent tubes 31G of a backlight device 3 are switched on successively in an order of arrangement so as to be synchronized with scanning of scanning lines in a liquid crystal panel 2, and so are cold cathode fluorescent tubes 31RB of the backlight device 3. In this embodiment, in a similar manner to the first embodiment, at a first half of one frame time period, a data signal is supplied to each in a group of data lines DL among data lines DL, which are connected to green pixels, and at a latter half of one frame time period, a data signal is supplied to each in a group of data lines DL among the data lines DL, which are connected to red pixels, and a data signal is supplied to each in a group of data lines DL among the data lines DL, which are connected to blue pixels.

Herein, the above-described expression “so as to be synchronized” means that in a 0.5 frame time period, the cold cathode fluorescent tubes 31G or the cold cathode fluorescent tubes 31RB are switched on sequentially from an upper side toward a lower side of a screen of the liquid crystal panel 2 so as to substantially track each one of scanning lines GL selected sequentially from the upper side toward the lower side of the screen of the liquid crystal panel 2, and does not necessarily require that timing for selecting the scanning lines GL be matched precisely with timing for switching on the cold cathode fluorescent tubes 31.

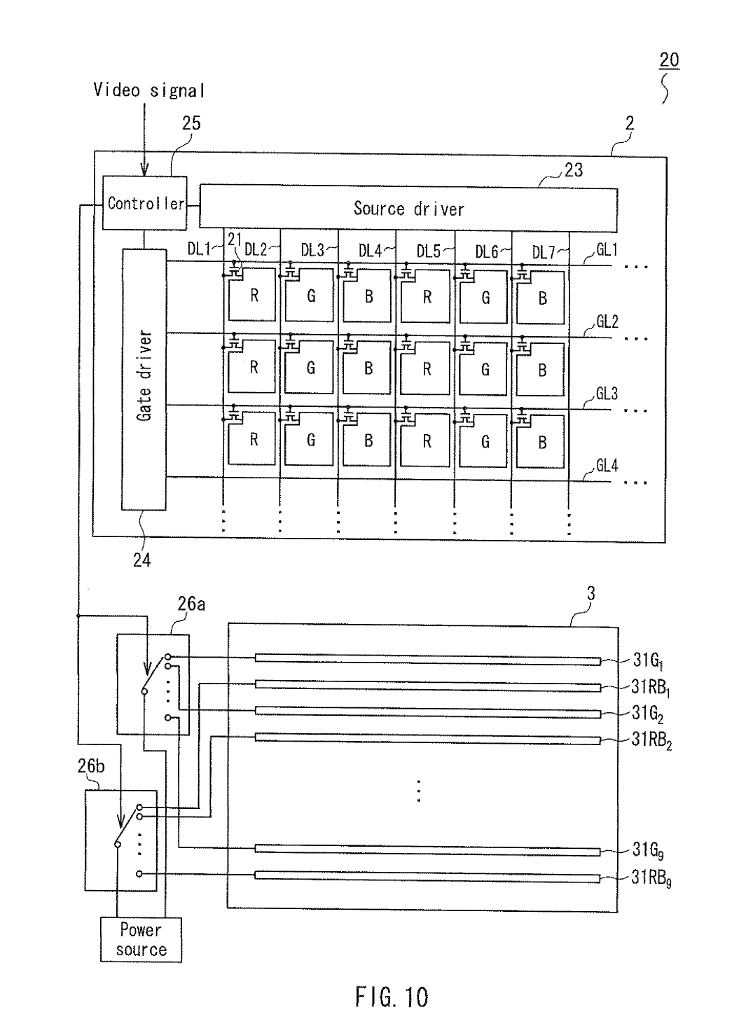

Therefore, as shown in FIG. 10, a liquid crystal display apparatus 20 according to this embodiment includes, in place of the switch circuit 26 in the liquid crystal display apparatus 1 according to the first embodiment, a switch circuit 26a that controls switching on/off of the green cold cathode fluorescent tubes 310 and a switch circuit 26b that controls switching on/off of the magenta cold cathode fluorescent tubes 31RB. In the following description, it is assumed that the liquid crystal display apparatus 20 includes 18 cold cathode fluorescent tubes in total composed of the green cold cathode fluorescent tubes 31G₁ to 31G₉ and the magenta cold cathode fluorescent tubes 31RB₁ to 31RB₉.

At a first half of one frame time period, the switch circuit 26a switches on the green cold cathode fluorescent tubes 31G₁ to 31G₉ one by one in this order in accordance with, for example, a timing signal supplied from a controller 25 of the liquid crystal panel 2. That is, in a period of 0.5 frames, the green cold cathode fluorescent tubes 31G₁ to 31G₉ are switched on one by one in order from the upper side toward the lower side of the screen of the liquid crystal panel 2 (from an upper side toward a lower side of FIG. 10). In a period of 0.5 frames, the scanning lines GL in the liquid crystal panel 2 are selected in order also in a direction from the upper side toward the lower side of the screen. Thus, at the first half of one frame time period, a position in the liquid crystal panel 2 that generally corresponds to one of the scanning lines GL to which a selection signal is being applied is irradiated with light from a corresponding one of the green cold cathode fluorescent tubes 31G.

Furthermore, at a latter half of one frame time period, the switch circuit 26b switches on the magenta cold cathode fluorescent tubes 31RB₁ to 31RB₉ one by one in this order in accordance with, for example, a timing signal supplied from the controller 25 of the liquid crystal panel 2. That is, in a period of 0.5 frames, the magenta cold cathode fluorescent tubes 31 RB₁ to 31RB₉ are switched on one by one in order from the upper side toward the lower side of the screen of the liquid crystal panel 2 (from the upper side toward the lower side of FIG. 10). In a period of 0.5 frames, the scanning lines GL in the liquid crystal panel 2 are selected in order also in the direction from the upper side toward the lower side of the screen. Thus, at the latter half of one frame time period, a position in the liquid crystal panel 2 that generally corresponds to one of the scanning lines GL to which a selection signal is being applied is irradiated with light from a corresponding one of the magenta cold cathode fluorescent tubes 31RB.

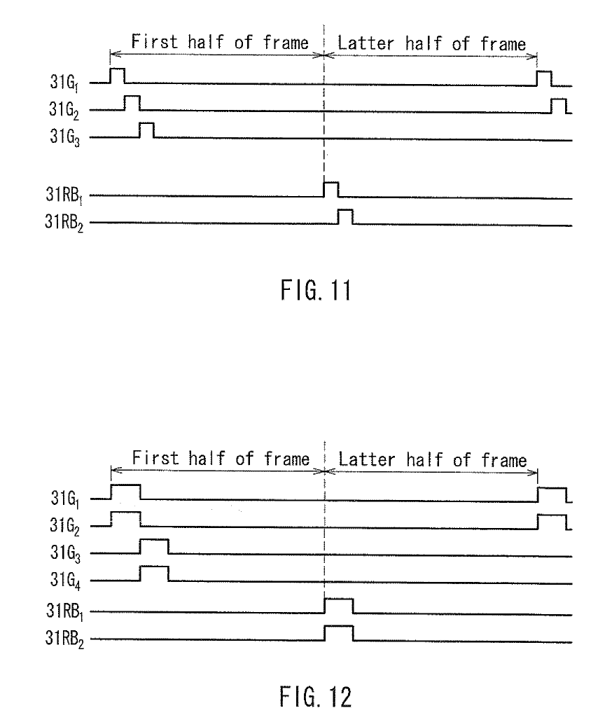

As a result of the above-described control performed by the switch circuits 26a and 26b, as shown in FIG. 11, in one frame time period, the cold cathode fluorescent tubes 31G and 31RB are switched on in an order of 31G₁, 31G₂, 31G₃, . . . 31G₉, 31RB₁, 31RB₂, 31RB₃, . . . 31RB₉. Even though a cold cathode fluorescent tube has a characteristic that the amount of light emitted thereby does not immediately change in response to the control of switching on/off as described above, in this embodiment, there is no possibility that light is emitted simultaneously by any combination of one of the green cold cathode fluorescent tubes 31G and one of the magenta cold cathode fluorescent tubes 31RB that are positioned in close proximity to each other. For example, in the case of a combination of the green cold cathode fluorescent tube 31G₁ and the magenta cold cathode fluorescent tube 31RB₁ adjacent thereto, the magenta cold cathode fluorescent tube 31RB₁ is switched on after a lapse of about 0.5 frame time period from the time when the green cold cathode fluorescent tube 31G₁ is switched off. Thus, there is no possibility that light from the green cold cathode fluorescent tube 31G₁ is mixed into light from the magenta cold cathode fluorescent tube 31RB₁. This allows further improved color purity to be obtained.

Furthermore, similarly to the liquid crystal display apparatus 1 of the first embodiment, also in the liquid crystal display apparatus 20 of this embodiment, at a first half of one frame time period, during lighting of the green cold cathode fluorescent tubes 31G that emit green light, a data signal supplied to each of the data lines DLL DL4, DL7, . . . that are connected to a group of pixel electrodes 22 among pixel electrodes 22 that corresponds to a red color filter and a data signal supplied to each of the data lines DL3, DL6, DL9, . . . that are connected to a group of pixel electrodes 22 among the pixel electrodes 22 that corresponds to a blue color filter may be maintained at a value of a potential applied in an immediately preceding frame, may have a predetermined potential value, or alternatively, may have such a potential value as to cause a black gradation display.

Similarly, at a latter half of one frame time period, during lighting of the magenta cold cathode fluorescent tubes 31RB, a data signal supplied to each of the data lines DL2, DL5, DL8, . . . that are connected to a group of pixel electrodes 22 among the pixel electrodes 22 that corresponds to a green color filter may be maintained at a value of a potential applied in an immediately preceding frame, may have a predetermined potential value, or alternatively, may have such a potential value as to cause a black gradation display.

In the foregoing description, the green cold cathode fluorescent tubes 31G₁ to 31G₉ and the magenta cold cathode fluorescent tubes 31RB₁ to 31RB₉ are set so as to be switched on one by one sequentially at a first half and a latter half of one frame time period, respectively. However, as long as light is not emitted simultaneously by one of the green cold cathode fluorescent tubes 31G and one of the magenta cold cathode fluorescent tubes 31RB that are positioned in dose proximity to each other, the effect of preventing the occurrence of color mixing can be obtained. From this viewpoint, the following configurations also are possible as modification examples.

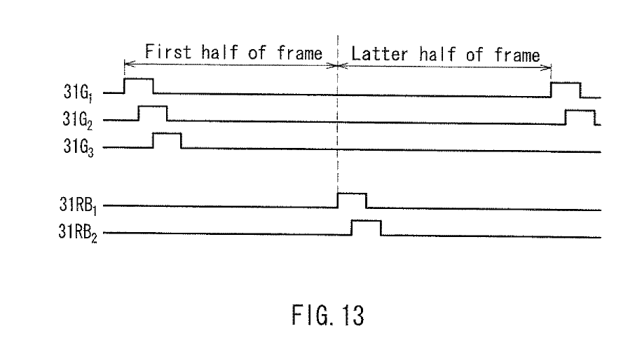

For example, the switch circuits 26a and 26b may be configured so that, as shown in FIG. 12, at a first half of one frame time period, the green cold cathode fluorescent tubes 31G₁ to 31G₉ are switched on sequentially in sets of two or more adjacent ones as one set, and at a latter half of one frame time period, the magenta cold cathode fluorescent tubes 31RB₁ to 31RB₉ also are driven to be switched on similarly to the above-described manner. Further, the switch circuits 26a and 26b also may be configured so that, as shown in FIG. 13, the cold cathode fluorescent tubes are switched on sequentially so that the respective periods of lighting time thereof overlap.

### Third Embodiment

The following describes an illumination device and a liquid crystal display apparatus including the same according to a third embodiment of the present invention. In the following description, configurations having functions similar to those of the configurations described in each of the above-described embodiments are denoted by the same reference characters, and detailed descriptions thereof are omitted.

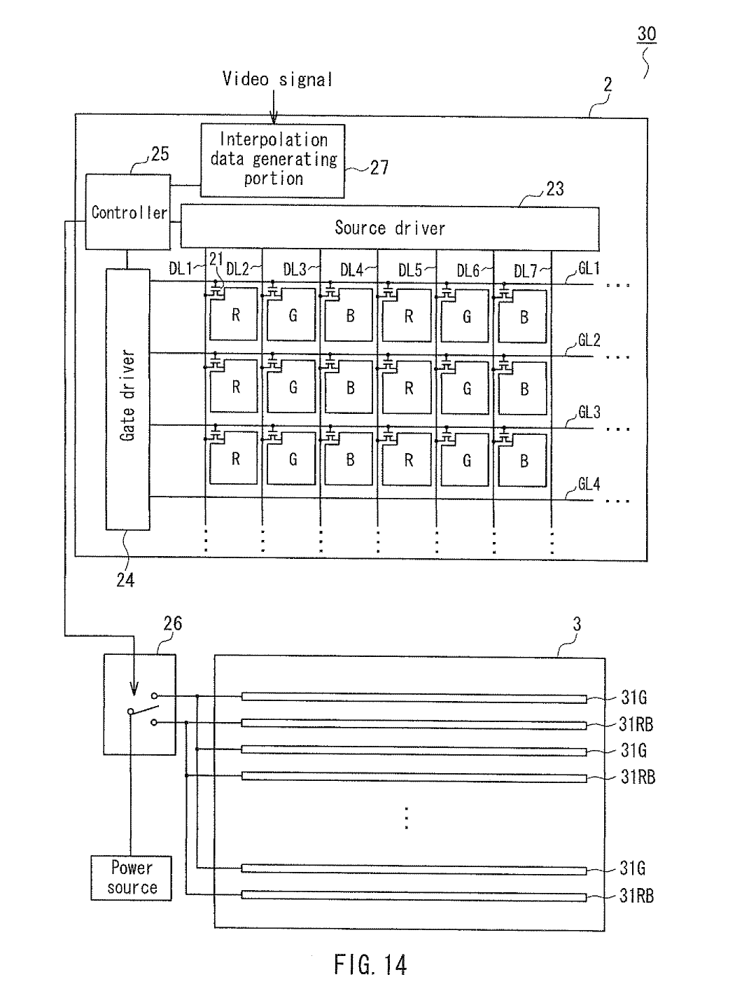

A liquid crystal display apparatus 30 according to this embodiment is different from the first embodiment in that, as shown in FIG. 14, it further includes an interpolation data generating portion 27 that generates a data signal to be supplied to one of data lines DL at a latter half of one frame time period by performing interpolation between a data signal to be supplied to the one of data lines DL in said frame time period and a data signal to be supplied to the one of data lines DL in a frame time period subsequent to said frame time period.

Similarly to the liquid crystal display apparatus 1 according to the first embodiment, in the liquid crystal display apparatus 30 of this embodiment, at a first half of one frame time period, green cold cathode fluorescent tubes 31G are switched on, while magenta cold cathode fluorescent tubes 31RB are switched off, and at a latter half thereof, the magenta cold cathode fluorescent tubes 31RB are switched on, while the green cold cathode fluorescent tubes 31G are switched off.

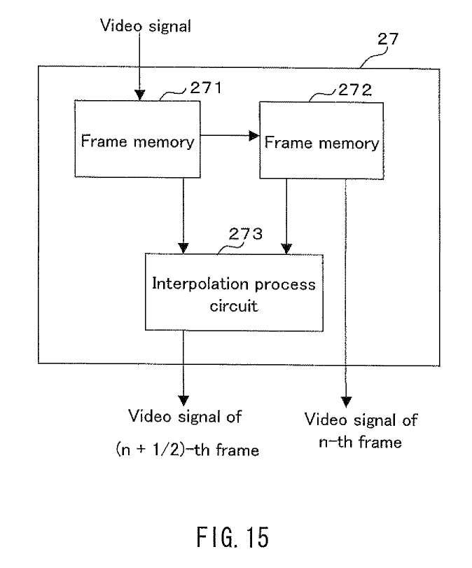

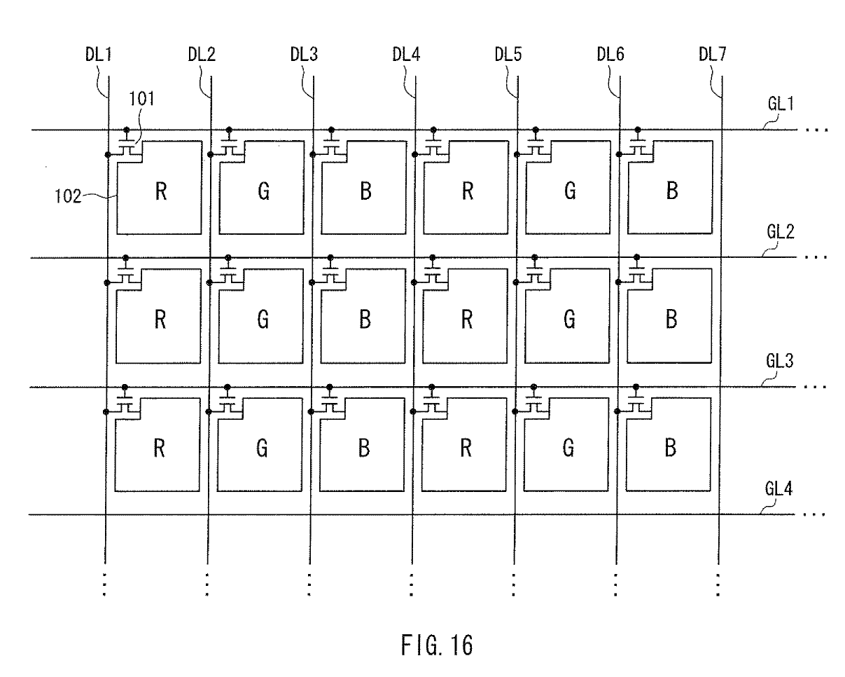

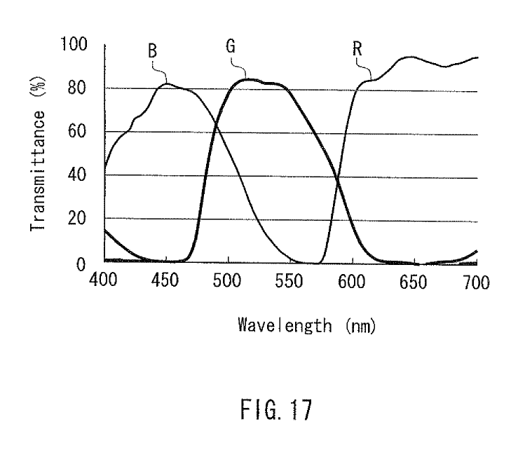

FIG. 15 is a block diagram showing an internal configuration of the interpolation data generating portion 27. As shown in FIG. 15, the interpolation data generating portion 27 includes frame memories 271 and 272 and an interpolation process circuit 273. One frame of a video signal is stored in each of the frame memories 271 and 272.

In the case where a video signal of a n-th frame is stored in the frame memory 271, when a video signal of a succeeding (n+1)-th frame is newly inputted to the interpolation data generating portion 27, the video signal of the n-th frame that has been stored in the frame memory 271 is transferred to the frame memory 272 to be stored in the frame memory 272. After that, the above-described newly inputted video signal of the (n+1)-th frame is stored in the frame memory 271. Therefore, it follows that two frames of video signals in total are stored respectively in the frame memories 271 and 272.

The interpolation process circuit 273 reads out the video signal of the n-th frame and the video signal of the (n+1)-th frame and generates a video signal corresponding to a (n+½)-th frame by an interpolation process. In the interpolation process performed by the interpolation process circuit 273, various well-known interpolation algorithms can be used, though descriptions thereof are omitted herein.

The video signal corresponding to the (n+½)-th frame generated by the interpolation process circuit 273 and the video signal of the n-th frame stored in the frame memory 272 are supplied to a source driver 23 via a controller 25.

At a first half of the n-th frame, the source driver 23 supplies a data signal of a green component of the video signal of the n-th frame to each in a group of data lines DL among the data lines DL, which are connected to green pixels, and at a latter half of the n-th frame, the source driver 23 supplies a data signal of a red component of the video signal corresponding to the (n+½)-th frame generated by the interpolation process circuit 273 to each in a group of data lines DL among the data lines DL, which are connected to red pixels and supplies a data signal of a blue component of the same video signal corresponding to the (n+½)-th frame to each in a group of data lines DL among the data lines DL, which are connected to blue pixels.

According to the above-described configuration, particularly, in the case where a moving picture is displayed, the occurrence of a color breaking (referred to also as color breakup) phenomenon can be reduced, which is caused due to images of the primary colors being separated in chronological order when displayed.

FIG. 14 shows an exemplary configuration including, similarly to the liquid crystal display apparatus 1 according to the first embodiment, a switch circuit 26 that, at a first half of one frame time period, switches on the green cold cathode fluorescent tubes 31G while switching off the magenta cold cathode fluorescent tubes 31RB, and at a latter half thereof, switches on the magenta cold cathode fluorescent tubes 31RB while switches off the green cold cathode fluorescent tubes 31G. However, a configuration also may be adopted in which in place of the switch circuit 26, the switch circuits 26a and 26b described in the second embodiment are provided.

The configurations described in each of the above-described embodiments are merely illustrative, and without limiting the technical scope of the present invention to the above-described specific examples, they can be modified variously.

For example, although each of the above-described embodiments shows an example using a cold cathode fluorescent tube as a light source for a backlight, in place thereof, a hot cathode fluorescent tube also can be used Further, phosphors presented specifically in the embodiments are no more than illustrative.

Moreover, the backlight device 3 is not limited to a direct type backlight as described above and may be an edge-light type backlight in which a light source is disposed on a side surface of a light-guiding body.

Furthermore, although each of the above-described embodiments shows an exemplary configuration including color filters of the three primary colors of RGB, the present invention also can be carried out using a configuration including color filters of three colors of CMY. Further, color filters applicable to the present invention are not limited to color filters of three colors, and the technical scope of the present invention encompasses a configuration including color filters of four or more colors including a color other than three colors that exhibit white when mixed (RGB or CMY). Further, although in each of the above-described embodiments, at a first half of one frame time period, a portion constituted of green pixels in one image is displayed, and at a latter half thereof, portions constituted of red pixels and blue pixels are displayed. However, a configuration also may be adopted in which at a first half, portions constituted of red pixels and blue pixels in one image are displayed, and at a latter half, a portion constituted of green pixels is displayed.

Furthermore, each of the above-described embodiments shows an exemplary configuration in which two types of light sources, i.e. a light source that emits light having a spectrum principally in a wavelength region of green and a light source of light having a spectrum principally in wavelength regions of red and blue are used as light sources for a backlight device. However, since deterioration in color purity is caused mainly by color mixing of green and blue, it is only required that a green component and a blue component be separated from each other. Thus, obviously, a configuration using two types of light sources that are a light source that emits light having a spectrum principally in a wavelength region of blue and a light source of light having a spectrum principally in wavelength regions of red and green also is suitable as an embodiment of the present invention and provides an effect equivalent to the effect obtained by each of the above-described embodiments.

### INDUSTRIAL APPLICABILITY

The present invention is industrially useful as an illumination device used as a backlight of a display apparatus and a display apparatus including the same.

1. An illumination device used as a backlight of a display apparatus, comprising:
a first light source that emits light of a first color; and
a second light source that emits light of a second color complementary to the first color,
wherein each of the first light source and the second light source is a fluorescent tube having a cold cathode or a hot cathode,
an amount of light emitted by the first light source is smaller than an amount of light emitted by the second light source, and
the first light source and the second light source can be controlled so as to be switched on independently of each other.

2. The illumination device according to claim 1,
wherein a plurality of the first light sources and a plurality of the second light sources are provided and arranged so as to alternate with each other one by one or in sets of a plural number of the first or second light sources.

3. The illumination device according to claim 1,
wherein an amount of electric power supplied to the first light source is smaller than an amount of electric power supplied to the second light source.

4. The illumination device according to any claim 1,
wherein an amount of electric current fed through the first light source is smaller than an amount of electric current fed through the second light source.

5. The illumination device according to claim 1,
wherein the first light source has an inner diameter larger than an inner diameter of the second light source.

6. The illumination device according to claim 1,
wherein a gas pressure inside the first light source is higher than a gas pressure inside the second light source.

7. The illumination device according to claim 1,
wherein the light of the first color has a spectrum principally in a wavelength region of green, and
the light of the second color has a spectrum principally in wavelength regions of red and blue.

8-9. (canceled)

10. The illumination device according to claim 1,
wherein the light of the first color has a spectrum principally in a wavelength region of blue, and
the light of the second color has a spectrum principally in wavelength regions of red and green.

11. A display apparatus, comprising:
a display element that includes:
scanning lines and data lines that are arranged in a matrix form;
a switching element that is connected to each of the scanning lines and a corresponding one of the data lines;
a pixel portion that performs a gradation display in accordance with a data signal written from the corresponding one of the data lines when the switching element is brought to an ON state based on a signal of the each of the scanning lines; and
color filters that are arranged so as to correspond to the pixel portions and include at least filters of three colors that exhibit a white color when mixed;
an illumination device that outputs plane-shaped light to the display element and includes a first light source that emits light of a first color that is one of the three colors and a second light source that emits light of a second color complementary to the first color, and in which each of the first light source and the second light source is a fluorescent tube having a cold cathode or a hot cathode, and an amount of light emitted by the first light source is smaller than an amount of light emitted by the second light source;
a scanning line driving portion that sequentially supplies a selection signal to each of the scanning lines at a cycle of half a time period in which one image is displayed in the display element;
a data line driving portion that, at one of a first half and a latter half of the time period in which one image is displayed in the display element, supplies a data signal to be written into each in a group of pixel portions among the pixel portions that corresponds to the color filter of the first color to a corresponding one of the data lines, and at an other of the first half and the latter half of the time period, supplies a data signal to be written into each in groups of pixel portions among the pixel portions that correspond respectively to the color filters of two colors among the three colors other than the first color to a corresponding one of the data lines; and
a light source driving portion that, at the one of the first half and the latter half of the time period in which one image is displayed in the display element, switches on the first light source while switching off the second light source, and at the other of the first half and the latter half of the time period, switches on the second light source while switching off the first light source.

12. The display apparatus according to claim 11,
wherein a plurality of the first light sources and a plurality of the second light sources are provided and arranged so as to alternate with each other one by one or in sets of a plural number of the first or second light sources.

13. The display apparatus according to claim 11,
wherein an amount of electric power supplied to the first light source is smaller than an amount of electric power supplied to the second light source.

14. The display apparatus according to claim 11,
wherein an amount of electric current fed through the first light source is smaller than an amount of electric current fed through the second light source.

15. The display apparatus according to claim 11,
wherein the first light source has an inner diameter larger than an inner diameter of the second light source.

16. The display apparatus according to claim 11,
wherein a gas pressure inside the first light source is higher than a gas pressure inside the second light source.

17. The display apparatus according to claim 11,
wherein the light of the first color has a spectrum principally in a wavelength region of green, and
the light of the second color has a spectrum principally in wavelength regions of red and blue.

18-19. (canceled)

20. The display apparatus according to claim 11,
wherein the light of the first color has a spectrum principally in a wavelength region of blue, and
the light of the second color has a spectrum principally in wavelength regions of red and green.

21. The display apparatus according to claim 11,
wherein at one of the first half and the latter half of the time period in which one image is displayed in the display element, the data line driving portion supplies a data signal for causing each in the groups of pixel portions among the pixel portions that correspond respectively to the color filters of two colors among the three colors other than the first color to perform a black gradation display to a corresponding one of the data lines, and at an other of the first half and the latter half of the time period in which one image is displayed in the display element, the data line driving portion supplies a data signal for causing each in the group of pixel portions among the pixel portions that corresponds to the color filter of the first color to perform a black gradation display to a corresponding one of the data lines.

22. The display apparatus according to claim 11,
wherein in the illumination device, a plurality of the first light sources and a plurality of the second light sources are provided so that a longitudinal direction of the first and second light sources is parallel to an extending direction of the scanning lines, and
at one of the first half and the latter half of the time period in which one image is displayed in the display element, the light source driving portion switches on the plurality of the first light sources successively in an order of arrangement so as to be synchronized with an application of the selection signal to each of the scanning lines, and at an other of the first half and the latter half of the time period in which one image is displayed in the display element, the light source driving portion switches on the plurality of the second light sources successively in an order of arrangement so as to be synchronized with the application of the selection signal to each of the scanning lines.

23. The display apparatus according to claim 11,
wherein an interpolation data generating portion further is provided that generates a data signal to be supplied to one of the data lines at the latter half of the time period in which one image is displayed in the display element by performing interpolation between a data signal to be supplied to the one of the data lines in said time period and a data signal to be supplied to the one of the data lines in a time period subsequent to said time period.
